(19) United States
(12) Patent Application Publication
(10) Pub. No.: US 2003/0049036 A1
(43) Pub. Date: Mar. 13, 2003

(54) Process cartridge, unit, and electrophotographic image forming apparatus

(75) Inventors: Takahito Ueno, Shizuoka (JP); Kazunari Murayama, Shizuoka (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/237,783

(22) Filed: Sep. 10, 2002

(30) Foreign Application Priority Data
Sep. 13, 2001 (JP) 277781/2001 (PAT.
Sep. 9, 2002 (JP) 262828/2002 (PAT.

(51) Int. Cl. G03G 15/00

(52) U.S. Cl. 399/25; 399/27

(57) ABSTRACT

A process cartridge and a unit include a cover member, a memory element provided on the cover member, and a unit abutting portion. The process cartridge and the unit can be detachably mounted to the main body of an electrophotographic image forming apparatus. The main body of an electrophotographic image forming apparatus includes a main body base member and communication means. The process cartridge and the unit are positioned to a predetermined location by the unit abutting portion abutting against the main body base member, when the process cartridge and the unit are mounted to the main body of the electrophotographic image forming apparatus. In this state, the storage element is disposed at a position facing the communication means and can communicate with it in a non-contacting manner.

### BACKGROUND OF THE INVENTION

1. Field of the Invention

The present invention relates to a process cartridge, a development cartridge, a toner cartridge, and a unit that are used in an electrophotographic image forming apparatus such as an electrophotographic copying machine or an electrophotographic printer, for example, and an electrophotographic image forming apparatus using them.

2. Description of Related Art

The electrophotographic image forming apparatus refers to an apparatus which forms images on a recording medium employing an electrophotographic image forming process.

It may include an electrophotographic copying machine, an electrophotographic printer (LED printer or laser beam printer), an electrophotographic facsimile apparatus, and an electrophotographic word processor, for example.

Further, a process cartridge may incorporate therein at least one of charging means, developing means, and cleaning means as process means and an electrophotographic photosensitive member as a cartridge which can be detachably mounted to the main body of an electrophotographic image forming apparatus, and may incorporate therein at least developing means as process means and an electrophotographic photosensitive member as a cartridge which can be detachably mounted to the main body of the apparatus.

A development cartridge may incorporate therein developing means for developing an electrostatic latent image formed on an electrophotographic photosensitive member and a toner containing portion for containing toner as a cartridge which can be detachably mounted the main body of the electrophotographic image forming apparatus.

A toner cartridge may incorporate therein a toner containing portion that contains toner for the development of an electrostatic latent image formed on an electrophotographic photosensitive member and a carrying member for agitating and carrying the toner as a cartridge which can be detachably mounted to the main body of the electrophotographic image forming apparatus.

A unit unitizes an electrophotographic photosensitive member alone, either or both of the development means and cleaning means as process means, or fixing means alone so that they can be detachably mounted to the main body of the electrophotographic image forming apparatus separately as a unit.

The unit, the process cartridge and the development cartridge can be attached to/detached from the main body of the apparatus by a user by his/her own, thereby allowing the main body of the apparatus to be maintained easily.

Conventionally, a process cartridge method has been utilized that integrally incorporate an electrophotographic photosensitive member and charging means, developing means, and cleaning means as process means as a cartridge which can be detachably mounted to the main body of the image forming apparatus.

The cartridge method has improved the operability of an image forming apparatus, allowing users to carry out the maintenance of the process means with ease on themselves. That is why the cartridge method is widely utilized in the main body of the image forming apparatus.

Also, such a cartridge configuration has been realized that incorporates process means as cartridges based on whether each means has a long life or a short life, so that they can be used according to the life of a primary process means. For example, a development cartridge that integrates a toner container having a toner containing portion and a developing member, or a drum cartridge that integrates an electrophotographic photosensitive member and charging means and cleaning means has been utilized.

For such cartridges, for example process cartridges, a method has been conventionally adopted that facilitates the maintenance of the main body of the electrophotographic image forming apparatus or a process cartridge by embedding a memory element (storage means) in a cartridge and registering service information in the memory element. And a method that carries out information communication between the main body of the electrophotographic image forming apparatus and a process cartridge in a non-contacting manner has been utilized.

### SUMMARY OF THE INVENTION

An object of the invention is to provide a unit that can ensure the communication between communication means provided in an electrophotographic image forming apparatus and storage means, a process cartridge, a development cartridge, and an electrophotographic image forming apparatus.

An another object of the invention is to provide a unit that can maintain a constant distance between communication means provided in an electrophotographic image forming apparatus and non-contacting storage means, a process cartridge, a development cartridge, and an electrophotographic image forming apparatus.

A further object of the invention is to provide a unit that can attempt to simplify the configuration of communication means provided in an electrophotographic image forming apparatus and the configuration of non-contacting storage means, a process cartridge, a development cartridge, and an electrophotographic image forming apparatus.

And a further object of the invention is to provide a unit which can be detachably mounted to the main body of an electrophotographic image forming apparatus having a main body base member fixedly disposed and communication means provided in the main body base member, comprising;

a cover member;

a unit abutting portion which is provided on the cover member and abuts against the main body base member, for positioning the unit to the main body of the apparatus when the unit is mounted to the main body of the apparatus; and

a memory element that is provided on the cover member and is disposed at a position facing the communication means, capable of communicating with the communication means in a non-contacting manner.

A further object of the invention is to provide a process cartridge that can be detachably mounted to the main body of an electrophotographic image forming apparatus having a main body base member fixedly disposed and communication means provided on the main body base member, comprising:

an electrophotographic photosensitive member;

process means for acting on the electrophotographic photosensitive member;

a cover member;

a unit abutting portion that is provided on the cover member and abuts against the main body base member, for positioning the process cartridge to the main body of the apparatus when the process cartridge is mounted to the main body of the apparatus; and

a memory element that is provided on the cover member and is disposed at a position facing the communication means, capable of communicating with the communication means in a non-contacting manner.

A further object of the invention is to provide a development cartridge that can be detachably mounted to the main body of an electrophotographic image forming apparatus having a main body base member fixedly disposed and communication means provided on the main body base member, comprising:

a developing member for developing an electrostatic latent image formed on an electrophotographic photosensitive member;

a toner container for containing toner to be supplied to the developing member;

a cover member;

a unit abutting portion that is provided on the cover member and abuts against the main body base member, for positioning the development cartridge to the main body of the apparatus when the development cartridge is mounted to the main body of the apparatus; and

a memory element that is provided on the cover member and is disposed at a position facing the communication means, capable of communicating with the communication means in a non-contacting manner.

A further object of the invention is to provide a toner cartridge that can be detachably mounted to the main body of an electrophotographic image forming apparatus having a main body base member fixedly disposed and communication means provided on the main body base member, comprising:

a toner container that contains toner to be supplied to a developing apparatus provided in the main body of the apparatus and has a toner supplying opening that supplies the toner to the developing apparatus;

a carrying member that agitates the toner in the toner container and carries it to the toner supplying port;

a cover member;

a unit abutting portion that is provided on the cover member and abuts against the main body base member, for positioning the toner cartridge to the main body of the apparatus when the toner cartridge is mounted to the main body of the apparatus; and

a memory element that is provided on the cover member and is disposed at a position facing the communication means, capable of communicating with the communication means in a non-contacting manner.

A further object of the invention is to provide an electrophotographic image forming apparatus to which a unit can be detachably mounted, for forming an image on a recording medium, having:

(i) a main body base member fixedly disposed,

(ii) communication means provided on the body base member,

(iii) mounting means for detachably mounting a unit that has a cover member; a unit abutting portion that is provided on the cover member and abuts against the main body base member, for positioning the unit to the main body of the electrophotographic image forming apparatus when the unit is mounted to the main body of the apparatus; and a memory element that is provided on the cover member and is disposed at a position facing the communication means, capable of communicating with the communication means in a non-contacting manner, and

(iv) conveying means for conveying the recording medium.

A further object of the invention is to provide an electrophotographic image forming apparatus to which a process cartridge can be detachably mounted, for forming an image on a recording medium, having:

(i) a main body base member,

(ii) communication means fixedly provided on the main body base member,

(iii) mounting means for detachably mounting a process cartridge that has an electrophotographic photosensitive member; process means affecting the electrophotographic photosensitive member; a cover member, a unit abutting portion that is provided integrally with the cover member and abuts against the main body base member when said unit is mounted to said apparatus main body, for positioning the direction in which the unit is mounted to the main body of the apparatus; a pushed portion that is pushed by the energizing means in the direction in which the unit abutting portion abuts against the main body base member; and a memory element that is fixedly disposed at a position on the cover member that faces the communication means, capable of communicating with the communication means in a non-contacting manner, and

(iv) conveying means for conveying the recording medium.

A further object of the invention is to provide an electrophotographic image forming apparatus to which a development cartridge can be detachably mounted, for forming an image on a recording medium, comprising:

(i) a main body base member,

(ii) communication means fixedly provided on the main body base member,

(iii) mounting means for detachably mounting a development cartridge that has a developing member for developing an electrostatic latent image formed on an electrophotographic photosensitive member; a toner container for containing toner to be supplied to the developing member; a cover member; a unit abutting portion that is provided on the cover member and abuts against the main body base member, for positioning the development cartridge to the main body of the apparatus when the development cartridge is mounted to the main body of the electrophotographic image forming apparatus; and a memory element that is provided on the cover member and is disposed a position facing the communication means, capable of communicating with the communication means in a non-contacting manner, and

(iv) a conveying means for conveying the recording medium.

A further object of the invention is to provide an electrophotographic image forming apparatus to which a toner cartridge is detachably mounted, for forming an image on a recording medium, comprising:

(i) a main body base member,

(ii) communication means fixedly provided on the main body base member,

(iii) mounting means for detachably mounting a development cartridge that has a toner container that contains toner to be supplied to a developing apparatus provided in the main body of the apparatus and has a toner supplying opening for supplying the toner to the developing apparatus; a carrying member that agitates the toner in the toner container and carries the toner to the toner supplying opening; a cover member; a unit abutting portion that is provided on the cover member and abuts against the main body base member, for positioning the toner cartridge to the main body of the electrophotographic image forming apparatus when the toner cartridge is mounted to the main body of the apparatus; and a memory element that is provided on the cover member and disposed at a position facing the communication means, capable of communicating with the communication means in a non-contacting manner, and

(iv) conveying means for conveying the recording medium.

### BRIEF DESCRIPTION OF THE DRAWINGS

The drawings relate to the embodiments of the present invention.

FIG. 1 is a longitudinal sectional view of the main body of an image forming apparatus;

FIG. 2 is a longitudinal sectional view of a process cartridge and a toner replenishment container;

FIG. 3 is a perspective view showing the general structure of the image forming apparatus;

FIG. 4 is a sectional view taken at the broken line 4-4 in FIG. 2;

FIG. 5 is a longitudinal sectional view of the toner replenishment container in the longitudinal direction;

FIG. 6 is a perspective view of the process cartridge;

FIG. 7 is a partial sectional view showing the process cartridge being mounted;

FIG. 8 is a sectional view showing the gap between a communication unit and a memory unit;

FIG. 9 is a perspective view of the memory unit;

FIG. 10 is a perspective view showing the memory unit being mounted;

FIG. 11 is a longitudinal sectional view of the memory unit; and

FIG. 12 is a front view of a base plate unit.

### DESCRIPTION OF THE PREFERRED EMBODIMENTS

In the following, a color electrophotographic image forming apparatus according to the invention will be described in conjunction with drawings. In the description below, a longitudinal direction refers to a direction that is orthogonal to the direction of conveying a recording medium and the same as the direction of the axis of an electrophotographic photosensitive member (hereafter a photosensitive drum 2). And “right” and “left” refer to the right and left as the conveying direction of the recording medium 52 seen from above. “Above” and “below” refer to above and below as a cartridge being mounted. The back side means the leading side of a process cartridge when a process cartridge is mounted to the main body of the apparatus in parallel with the photosensitive drum 2. And front side means the opposite side of the back side.

### Description of the General Structure of an Image Forming Apparatus

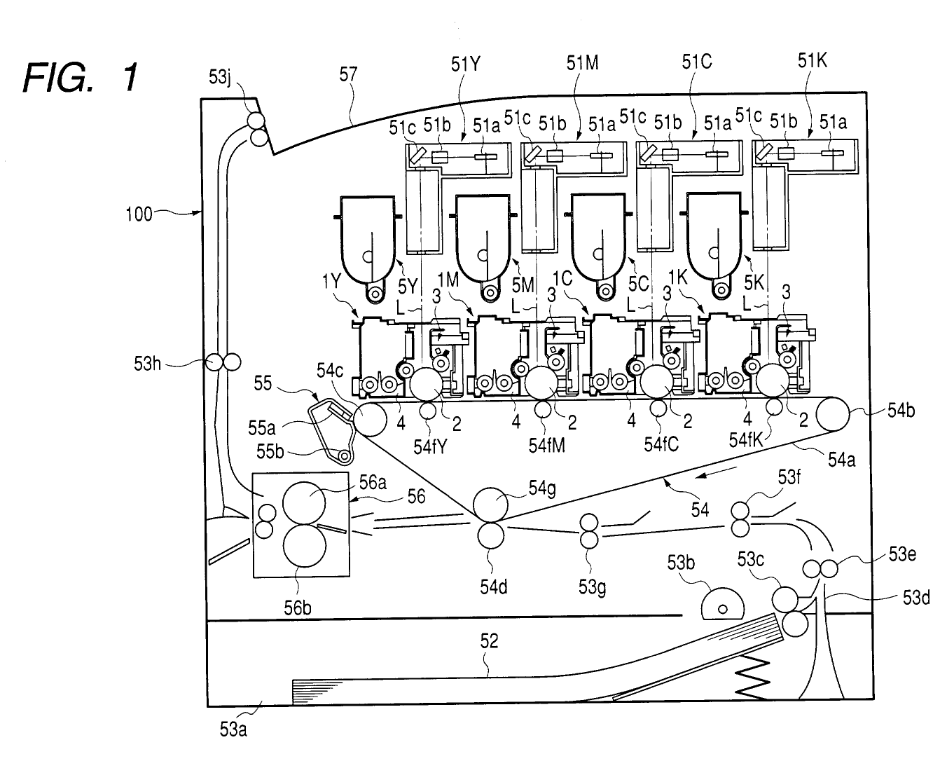

First, the general configuration of a color electrophotographic image forming apparatus will be generally described with reference to FIG. 1.

FIG. 1 illustrates the general configuration of a color laser beam printer that is an embodiment of the color toner image forming apparatus.

In the image forming section of the color laser beam printer, four process cartridges having a photosensitive drum 2 as an image bearing body, 1Y, 1M, 1C, and 1K (yellow, magenta, cyan, and black), and above the process cartridges 1Y, 1M, 1C, and 1K, exposure means corresponding to each color, 51Y, 51M, 51C, and 51K (laser beam optical scanning system) are respectively positioned in parallel.

Below the image forming section, feeding means for feeding a recording medium 52, an intermediate transferring belt 54a that transfers a toner image formed on the photosensitive drum 2, and a secondary transferring roller 54d that transfers an toner image on the intermediate transferring belt 54a onto the recording medium 52 are arranged.

In addition, fixing means for fixing the recording medium 52 with a toner image transferred thereon, and discharge means for discharging the recording medium 52 out of the apparatus and stacking it are disposed.

The recording medium 52 includes paper, OHP sheet, or cloth, for example.

The image forming apparatus of the embodiment is an apparatus that uses cleaner-less system: transfer residual toner remaining on the photosensitive drum 2 is taken into the developing means, thus a dedicated cleaner for collecting and storing transfer residual toner is not provided in the process cartridge.

Now, the configuration of each part of the image forming apparatus will be sequentially described in detail.

### Sheet Feeding Section

A sheet feeding section is for feeding a recording medium 52 to the image forming section, consisting mainly of a feeding cassette 53a in which a plurality of recording media are contained as stacked, a feeding roller 53b, a retard roller 53c for preventing double feeding, a feeding guide 53d, and a registration roller 53g.

The feeder roller 53b is driven to rotate in accordance with image forming operations and feeds a recording medium 52 in the feeding cassette 53a one by one separately. The recording medium 52 is guided by the feeding guide 53d to be conveyed to the registration roller 53g via the conveying rollers 53e and 53f.

Immediately after the recording medium 52 is conveyed, the registration roller 53g stops rotating, and the skew-feeding of the recording medium 52 is prevented by the medium hitting (contacting) against the nip portion of the registration roller 53g.

During image forming operations, the registration roller 53g performs non-rotating operation of keeping the recording medium 52 in a stationary state, and rotating operation of feeding the recording medium 52 to the intermediate transferring belt 54a in a predetermined sequence, positioning a toner image and the recording medium 52 for the following transferring process.

### Process Cartridge

In the process cartridges 1Y, 1M, 1C, and 1K, charging means and developing means are positioned around the photosensitive drums 2 as image bearing body, which are integrally incorporated. And these process cartridges 1Y, 1M, 1C, and 1K can be easily mounted to/removed from the main body of the apparatus 100 by a user and replaced upon the photosensitive drum 2 reaching its life.

In the embodiment, the rotation of the photosensitive drum 2 is counted so that it is informed that the process cartridge 1Y, 1M, 1C, or 1K has worn out when a predetermined count number is exceeded, for example.

The photosensitive drum 2 of the embodiment is a negatively-charged organic photosensitive member and has a photosensitive member layer normally used on top of a aluminum drum base having a diameter of 30 mm, a charge injecting layer being provided on the outermost layer. And the drum 2 is rotated at a predetermined process speed, approximately 17 mm/sec for the embodiment.

The charge injecting layer uses a coated layer of material with SnO₂ ultra-fine particle, for example, as conductive ultra-fine particle dispersed over a binder made of an insulative resin.

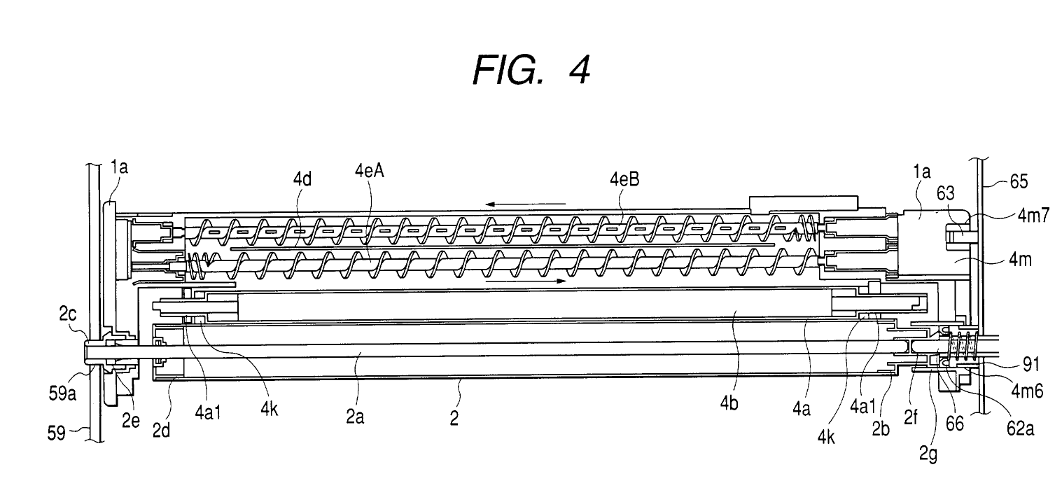

As shown in FIG. 4, a drum flange 2b is fixed at the end of the back side of the photosensitive drum 2, and a non-driven flange 2d is fixed at the end of the front side. A drum shaft 2a passes through the center of the drum flange 2b and the non-driven flange 2d, so the drum shaft 2a, the drum flange 2b, and the non-driven flange 2d are rotated together. Namely, the photosensitive drum 2 is rotated about the axis of the drum shaft 2a.

The front side end of the drum shaft 2a is rotatably supported by a beating 2e, and the bearing 2e is fixed to a bearing case 2c. And the bearing case 2c is fixed to a frame 1a of the process cartridge 1.

### Charging Means

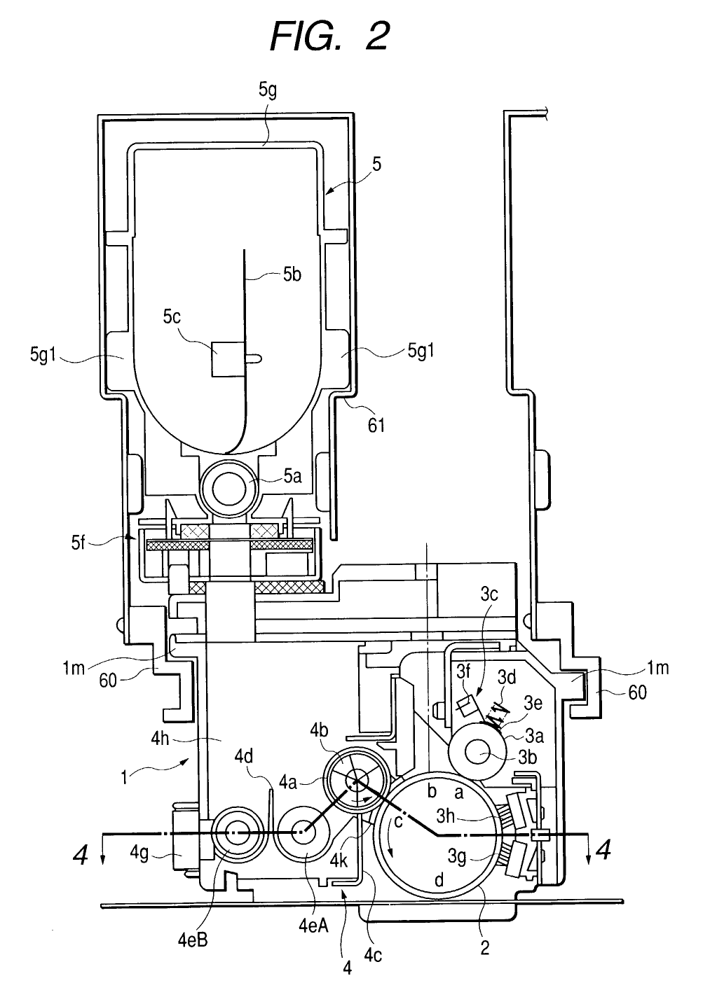

The charging means employs a contact charging method. In the embodiment a charging roller 3a is used as a charging member. shown in FIG. 2, both ends of center wire 3b are each rotatably supported by bearing members (not shown), and the charging roller 3a is energized (biased) in the direction of the photosensitive drum by a push spring 3d to be pressed against the surface of the photosensitive drum 2 under a certain pressure, rotating in accordance with the rotation of the photosensitive drum 2. 3c is a charging roller cleaning member, a cleaning film having flexibility in the embodiment. The cleaning film 3e is positioned in parallel with the longitudinal direction of the charging roller 3a and has its one end fixed by a supporting member 3f that performs a certain amount of reciprocation in the longitudinal direction, such that the film 3e form a contact nip with the charging roller 3a on the plane in the proximity of the free end side. A supporting member 3f is reciprocated for a certain amount in the longitudinal direction by driving means (not shown), the surface of the charging roller fractionized by the cleaning film 3e. This removes accretion (fine powder toner, external additives or the like) from the charging roller surface.

The image forming apparatus of the embodiment adopts the cleaner-less system.

Next, the cleaner-less system will be described.

### Cleaner-less System

To summarize the cleaner-less system for the image forming apparatus of the embodiment: transfer residual toner on the photosensitive drum 2 after transferring is carried to the developing portion c through the charging portion a and exposure portion b with following rotation of the photosensitive drum 2, and cleaned (collected) by the developing apparatus 4 simultaneously with development.

The exposure process is carried out over transfer residual toner since transfer residual toner on the photosensitive drum 2 surface passes through the exposure portion b, however, significant effect is not caused because the amount of transfer residual toner is little.

However, transfer residual toner include residual toner of normal polarity, of reverse polarity (reverse toner), and of little charging amount, and the charging roller 3a would be inadmissibly contaminated by toner to cause charging failure because of reverse toner or toner with little amount of charge being adhered to the charging roller 3a in passing the charging portion a of FIG. 2.

And to effectively carry out the cleaning of transfer residual toner on the photosensitive drum surface by the developing device 4 simultaneously with development, it is required that the charging polarity of transfer residual toner on the photosensitive drum to be carried to the developing portion c of FIG. 2 is normal polarity, and that its charge amount is enough for the developing apparatus 4 to develop an electrostatic latent image on the photosensitive drum 2. Reverse toner and toner of inappropriate charge amount cannot be removed and collected from the photosensitive drum by the developing apparatus 4, resulting in inferior images.

Also, as users' needs have diversified in these years, sequential printing operation of images with high printing rate such as photographic images creates a large amount of transfer residual toner at a time, thereby exacerbating the problems mentioned above.

Therefore, in the embodiment, transfer residual toner (residual developer image) uniformizing means 3g for uniformizing transfer residual toner on the photosensitive drum 2 is provided at a position downstream from the transferring portion d of FIG. 2 in the moving direction of the periphery of the photosensitive drum 2. And at a point that is downstream from the transfer residual toner uniform uniformizing means 3g in the moving direction of the periphery of the photosensitive drum 2 and is upstream from the charging portion a of FIG. 2 in the moving direction of the periphery of the photosensitive drum 2, toner (developer) charging control means 3h for matching charge polarity of transfer residual toner to negative polarity, i.e., normal polarity.

By providing the transfer residual toner uniformizing means 3g, transfer residual toner on patterns on the photosensitive drum to be carried from the transferring portion d of FIG. 2 to the toner charging control means 3h is distributed and dispersed over the photosensitive drum surface in a non-pattern, even if the amount of transfer residual toner on the photosensitive drum is large. Therefore, toner will not concentrate on a portion of the toner charging control means 3h, and the toner charging control means 3h can always perform the normal polarity charging for entire transfer residual toner sufficiently, effectively preventing transfer residual toner from adhering to the charging roller 3a. Occurrence of a ghost image corresponding to transfer residual toner image pattern can be also prevented.

In the embodiment, the transfer residual toner uniformizing means 3g and the toner charging control means 3h are brush-like members with an appropriate conductivity, their brush portions positioned in contact with the photosensitive drum surface.

These means are moved (reciprocated) in the longitudinal direction of the photosensitive drum 2 by a driving source (not shown). This can prevent the transfer residual toner uniformizing means 3g and the toner charging control means 3h from staying at the same position on the photosensitive drum. For example, even if over-charged portion or under-charged portion due to uneven resistance of the toner charging control means 3h exist, it would not always occur on the same position on the photosensitive drum surface. Accordingly, the occurrence of fusion on the photosensitive drum due to local overcharge of transfer residual toner, and adhesion of transfer residual toner to the charging roller 3a due to inadequacy of charging can be prevented or alleviated.

### Exposure Means

In the embodiment, exposure to the photosensitive drum 2 is carried out using laser exposure means. That is, when an image signal is sent from the main body of the apparatus 100, laser L that has been modulated correspondingly is scanned and exposed to the uniform charged surface of the photosensitive drum 2. An electrostatic latent image corresponding to image information is then selectively formed on the photosensitive drum 2 surface.

Laser exposure means consists of solid laser elements (not shown), a polygon mirror 51a, an imaging lens 51b, and a reflecting mirror 51c and so on. Based on an inputted image signal, solid laser elements are controlled to emit light on/off with a predetermined timing by an emission signal generator (not shown). Laser L radiated from the solid laser elements is converted to an approximately parallel luminous flux by a collimator lens system (not shown) and scanned by a polygon mirror 51a rotating at a high speed. And it is imaged onto the photosensitive drum 2 in a spot via the imaging lens 51b and the reflecting mirror 51c.

Thus, exposure in main scanning direction with laser scanning and exposure in sub-scanning direction with the rotation of the photosensitive drum 2 are carried out to the surface of the photosensitive drum 2, resulting in exposure distribution corresponding to an image signal.

That is, the radiation and non-radiation of laser L form a light portion potential with lower surface potential and a dark portion potential without lower potential. And the contrast between the light portion potential and dark portion potential forms an electrostatic latent image corresponding to image information.

### Developing Means

The developing apparatus 4 as developing means is a two-component contact developing apparatus (two-component magnetic brush developing apparatus), and, as shown in FIG. 2, holds developer consisting of carrier and toner on a developing sleeve 4a as developer bearer that contains a magnet roller 4b therein. A regulation blade 4c is provided on the developing sleeve 4a with a certain gap therebetween, forming a thin layer of developer on the developing sleeve 4a as the developing sleeve 4a rotates in the direction indicated by the arrow.

As shown in FIG. 4, the developing sleeve 4a is positioned at a certain gap from the photosensitive drum 2 by rotatably fitting spacers 4k into journal portions 4a1 with a smaller diameter at the both ends of the sleeve. And during development, developer formed on the developing sleeve 4a can be developed in contact with the photosensitive drum 2. Here, the spacer 4k is a cylinder that has a larger outer diameter than that of the developing sleeve 4a so that a space for developing is created therebetween. The peripheral surface of the developing sleeve 4a moves in a direction counter to the moving direction of the periphery of the photosensitive drum 2, thus the sleeve 4a is rotated in the clockwise direction indicated by the arrow at a certain peripheral velocity.

In the embodiment, negatively charged toner having an average particle diameter of 6 μm is used for toner, and magnetic carrier having saturation magnetization of 205 emu/cm³ and an average particle diameter of 35 μm is used for magnetic carrier. And a mixture of toner and carrier at a weight ratio of 6:94 is employed as developer.

A developer containing portion 4h in which developer circulates is partitioned into two by a longitudinal dividing wall 4d except for both ends. And agitating screws 4eA and 4eB are positioned on the opposite sides of the wall 4d.

As shown in FIG. 4, toner replenished by a toner replenishment container 5 falls into the back side of the agitating screw 4eB and is agitated as being sent toward the front side of longitudinal direction, passing through the portion at the front side end without the dividing wall 4d. The toner is then sent to the back side of the longitudinal direction by the agitating screw 4eA and passes through the portion at the back side without the dividing wall 4d to be agitated by the agitating screw 4eB as being sent, thus repeating circulation.

The developing process which visualizes an electrostatic latent image formed on the photosensitive drum 2 employing the two-component magnetic brush method of the developing apparatus 4 and the circulating system of developer will be now described.

As the developing sleeve 4a rotates, developer in the developer containing portion is pumped by pumping pole of the magnet roller 4b onto the surface of the developing sleeve 4a and carried.

The layer thickness of the developer is regulated by a regulation blade 4c positioned vertically to the developing sleeve 4a, and a thin layer of developer is formed on the developing sleeve 4a. When the thin layer of developer is carried to a developing pole corresponding to the developing portion c of FIG. 2, a spike is formed by magnetic force. An electrostatic latent image on the photosensitive drum 2 surface is developed as a toner image by the toner in developer formed in this spike shape. In this instance, the electrostatic latent image is reversely developed.

After passing the developing portion c of FIG. 2, the thin layer of developer on the developing sleeve 4a then enters the developer containing portion as the developing sleeve 4a rotates, leaves the developing sleeve 4a due to the repulsive magnetic field of carrying pole to be pulled back to developer pool in the developer containing portion.

Direct current (DC) voltage and alternate current (AC) voltage are applied to the developing sleeve 4a from a power supply (not shown). In the embodiment, a DC voltage of −500 V and an AC voltage having a peak-to-peak voltage of 1500 V at a frequency of 200 Hz are applied to develop only exposed portions on the photosensitive drum 2.

In general, with the two-component developing method, the application of AC voltage improves the efficiency of development and image quality, but in turn fog can occur easily. Accordingly, a potential difference is normally provided between the DC voltage applied to the developing sleeve 4a and the surface potential of the photosensitive drum 2 so that the prevention of fog can be realized. More specifically, a bias voltage of the potential between the potential of the exposure portion of the photosensitive drum 2 and the potential of non-exposed portion is applied.

As toner is consumed for development, toner concentration of developer gets lower.

In the embodiment, a sensor 4g for detecting toner concentration is disposed at a position close to the outer periphery of the agitating screw 4eB. When the sensor 4g detects that the toner concentration of developer has fallen below a predetermined concentration level, an instruction is issued for replenishing toner from the toner replenishment container 5 to the developing device 4. This toner replenishment operation maintains and controls toner concentration of developer at a predetermined level all the time.

### Toner Replenishment Container

Toner replenishment containers 5Y, 5M, 5C, and 5K are positioned in parallel above the process cartridges 1Y, 1M, 1C, and 1K, and are mounted from the front side of the main body of the apparatus 100.

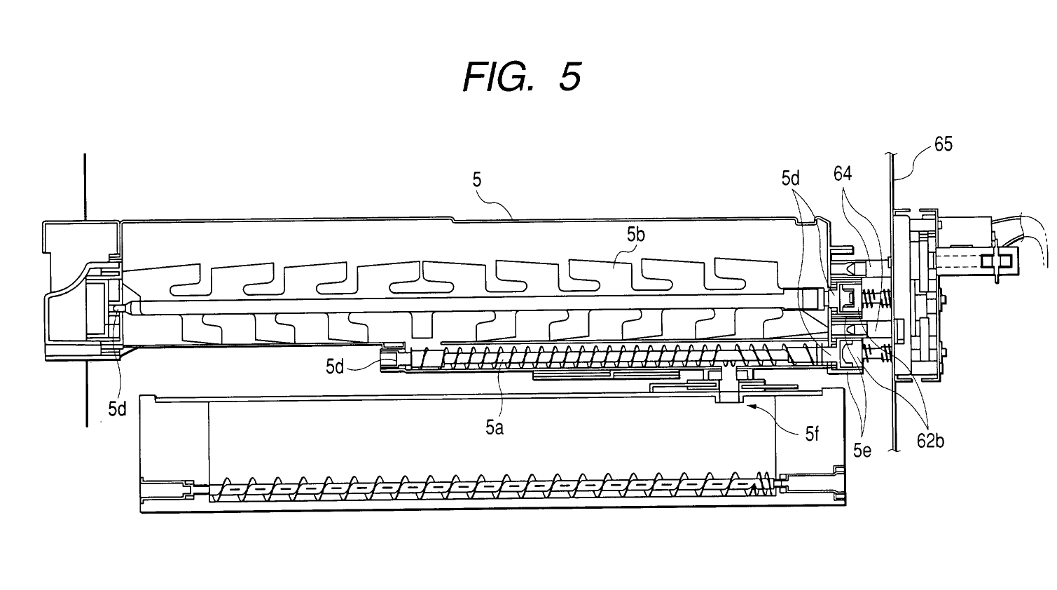

As shown in FIG. 2, an agitating plate 5b fixed to an agitating axis 5c and a screw 5a are positioned inside the toner replenishment container 5, a discharge opening 5f for discharging toner being formed at the bottom of the container. As shown in FIG. 5, the screw 5a and the agitating axis 5c are rotatably supported at their both ends by bearings 5d, and drive couplings (concave) 5e are positioned at one end. The drive couplings (concave) 5e receive driving transmission from drive couplings (convex) 62b and is rotated. The exterior of the screw 5a has a spiral ribbed shape, and the twisting direction of the spiral is reversed at the discharge opening 5f. The rotation of the drive coupling (convex) 62b causes the screw 5a to rotate in a predetermined rotational direction. And toner is carried toward the discharge opening 5f and falls freely from the opening of the discharge opening 5f so that the toner is replenished to the process cartridge 1. The tip of the agitating plate 5b in the direction of its turning radius is inclined, and when it contacts the wall of the toner replenishment container 5 in a sliding manner, it abuts against the wall at a certain angle. Specifically, the tip of the agitating plate 5b is twisted to form a spiral shape. The tip of the agitating plate 5b being twisted and inclined causes conveying force in the axis direction, carrying toner in the longitudinal direction.

The toner replenishment container 5 of the embodiment may supply toner not only with the two-component developing method but with a process cartridge or a development cartridge using the one-component developing method. It should be noted that the powder contained in the toner replenishment container is not limited to toner but may be what is called two-component developer that is a mixture of toner and magnetic carrier.

### Transferring Means

The intermediate transferring unit 54 as transferring means secondarily transfers a plurality of toner images, which have been primarily transferred from the photosensitive drum 2 and overlapped in sequence, onto the recording medium 52 all at once.

As shown in FIG. 1, the intermediate transferring unit 54 comprises an intermediate transferring belt 54a, which runs in the clockwise direction indicated by the arrow at a peripheral velocity approximately the same as the outer peripheral velocity of the photosensitive drum 2. The intermediate transferring belt 54a is an endless belt having a peripheral length of about 940 mm, and is supported by three rollers: a drive roller 54b, a secondary transfer opposed roller 54g, and a driven roller 54c.

Inside the intermediate transferring belt 54a, each of transfer charging rollers 54fY, 54fM, 54fC, and 54fK are rotatably disposed at positions opposed to each photosensitive drum 2, and are pressed toward the center of the photosensitive drum 2.

Transfer charging rollers 54fY, 54fM, 54fC, and 54fK are fed from a high-voltage power supply (not shown), and carry out charging with reverse polarity as toner from the back side of the intermediate transferring belt 54a and primarily transfers toner images on the photosensitive drum 2 onto the upper surface of the intermediate transferring belt 54a in sequence.

At the secondary transferring portion, a secondary transferring roller 54d as a transferring member is pressed against the intermediate transferring belt 54a at a position opposed to the secondary transfer opposed roller 54g. The secondary transferring roller 54d can rock up and down and rotate in the figure. At the same time, a bias is applied to the intermediate transferring belt 54a, thus toner images on the intermediate transferring belt 54a is transferred to the recording medium 52.

The intermediate transferring belt 54a and the secondary transferring roller 54d are individually driven. When the recording medium 52 enters the secondary transferring portion, a predetermined bias is applied to the secondary transferring roller 54d and a toner image on the intermediate transferring belt 54a is secondarily transferred to the recording medium 52.

Concurrently with the transfer process, the recording medium 52 between the belt 54a and the roller 54d is conveyed in the left direction in the figure at a predetermined speed toward the next process, a fixing device 56.

At a predetermined position on the intermediate transferring belt 54a that is the far end of downstream of the transfer process, a cleaning unit 55 that can come into contact with/move away from the surface of the intermediate transferring belt 54a is provided, removing transfer residual toner remaining after the secondary transfer.

Inside the cleaning unit 55, a cleaning blade 55a for removing transfer residual toner is positioned. The cleaning unit 55 is mounted about a rotational center (not shown) such that it can rock, and the cleaning blade 55a is pressed against the intermediate transferring belt 54a in the direction it engages with the belt 54a.

Transfer residual toner taken into the cleaning unit 55 is conveyed to a removed toner tank (not shown) by a conveying screw 55b and stored therein.

The intermediate transferring belt 54a can be made of polyimide resin. The material is not limited to polyimide resin: plastics such as polycarbonate resin, polyethylene terephthalate resin, polyvinyl fluoride resin, polyethylene naphthalate resin, polyether ether ketone resin, polyethersulphone resin, polyurethane resin, and fluororubber and silicone rubber can be favorably used.

### Fixing Section

A toner image formed on the photosensitive drum 2 by the development means is transferred onto the recording medium 52 through the intermediate transferring belt 54a. And the fixing device 56 fixes the toner image transferred to the recording medium 52 by means of heat.

As shown in FIG. 1, the fixing device 56 comprises a fixing roller 56a for applying heat to the recording medium 52 and a pressure roller 56b for pressing the recording medium 52 against the fixing roller 56a, each roller being a hollow roller. Each roller has a heater (not shown) therein. And the rollers are rotated so that the recording medium 52 is conveyed simultaneously.

That is, the recording medium 52 bearing a toner image is conveyed by the fixing roller 56a and the pressure roller 56b, and at the same time the toner image is fixed to the recording medium 52 by applying heat and pressure. The fixed recording medium 52 is discharged by discharge rollers 53h and 53j to be stacked in a tray 57 on the main body of the apparatus 100.

### Mounting a Process Cartridge and a Toner Replenishment Container

Next, the mounting procedure of a process cartridge and a toner replenishment container will be described with FIGS. 2, 3, 4, and 6. As shown in FIG. 2, a openable and closable front door 58 is positioned at the front of the main body of the apparatus 100: pulling the font door 58 open, an opening for inserting the process cartridges 1 (a character representative of 1Y, 1M, 1C, and 1K) and the toner replenishment containers 5 (a character representative of 5Y, 5M, 5C, and 5K) is exposed.

A centering plate 59 which is turnably supported is positioned at the opening 5 for inserting the process cartridge 1, and a process cartridge is inserted or pulled out after the centering plate 59 is opened.

As shown in FIG. 2, a guide rail 60 for guiding the attachment of the process cartridge 1 and a guide rail 61 for guiding the attachment of the toner replenishment container 5 are fixed inside the main body of the apparatus 100. At the both ends of the upper surface of the process cartridge 1, guiding portions 1m in the longitudinal direction are provided. A toner replenishment container 5 is provided with guiding portions 5g1 in the longitudinal direction at the right and left of the container proper 5g.

The direction in which the process cartridge 1 and the toner replenishment container 5 are mounted is parallel to the direction of the photosensitive drum 2 axis, the guide rails 60 and 61 also disposed in a similar direction. The process cartridge 1 and the toner replenishment container 5 are inserted from the front of the main body of the apparatus 100 and slid along the guide rails 60 and 61 toward the back side, with the guide rails 60 and 61, and guiding portions 1m and 5g1 engaged.

When the process cartridge is inserted as far as it goes, centering axis 66 of the main body of the apparatus 100 is inserted to the center hole 2f of the drum flange 2b as shown in FIG. 4, which positions the rotational center position of the back side of the photosensitive drum 2 to the main body of the apparatus 100. At the same time, a drive transmitting portion 2g formed on the drum flange 2b and the drive coupling (concave) 62a are connected to allow the photosensitive drum 2 to rotate. The drive transmitting portion 2g forms a shape of twisted triangle pole, and the drive coupling (concave) 62a forms a hole of twisted triangle pole. The drive coupling 62a moves forward to fit the drive conveying portion 2g. The application of driving force from the main body of the apparatus 100 to the drive coupling (concave) 62a transmits driving force and also generates a force that draws the photosensitive drum 2 backward.

Moreover, a supporting pin 63 as a main body supporting member for positioning the process cartridge 1 is positioned on the back side plate 65 fixed to the main body of the apparatus 100, and the supporting pin 63 is inserted to the long hole 4m7 in the frame 1a of the process cartridge 1, and a hole 4m6 as a cylindrical member in the driving part side cover 4m as a part of the frame 1a fits the cylindrical portion 91a of the frame supporting member 91 supporting the cartridge frame of the process cartridge 1 so that the radial direction is regulated.

A turnable centering plate 59 positioned at the front side of the main body of the apparatus 100, the bearing case 2c fits into the hole 59a in the centering plate 59 and the bearing case 2c of the process cartridge 1 is supported and fixed to the centering plate 59. The sequence of these insertion operations positions the photosensitive drum 2 and the process cartridge 1 to the main body of the apparatus 100.

Meanwhile, as shown in FIG. 5, the toner replenishment container 5 is fixed to the supporting pin 64 protruding from the back side plate 65 when the toner replenishment container 5 is inserted to the as far as it goes. At the same time, the drive coupling (concave) 5e and the drive coupling (convex) 62b are connected, allowing the screw 5a and the agitating axis 5c to rotate.

### Embodiments

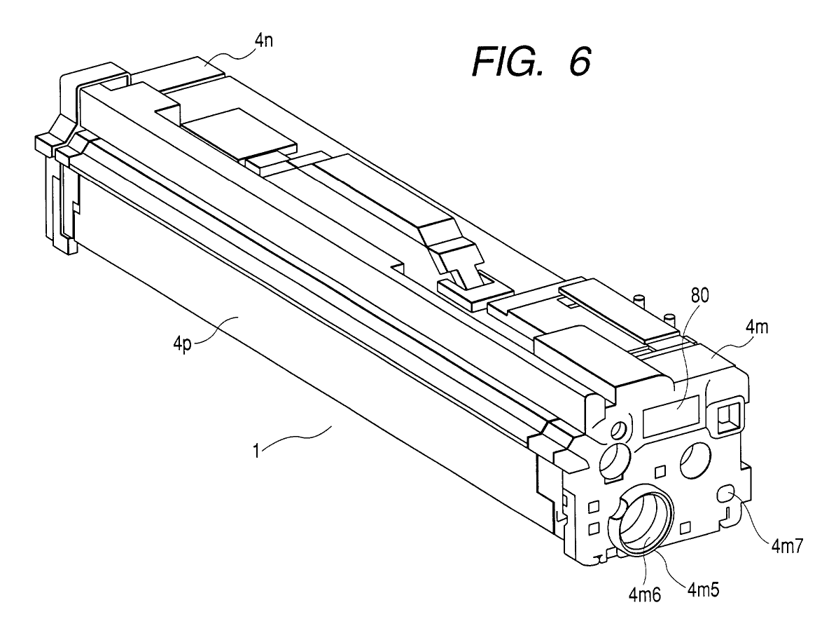

The embodiments of the invention will be now described with FIGS. 6, 7, and 8.

### Description of Memory System

The memory system of the embodiment utilizes a method that a magnetic core as a communication antenna is provided at process cartridge side of a position where the main body of the image forming apparatus 100 contacts the process cartridge 1, and an inductor as a communication antenna is provided on the side of the main body of the image forming apparatus, so that information communication between the main body of the image forming apparatus 100 and the process cartridge 1 is made with radio by means of electromagnetic induction of inductor induction via the magnetic core.

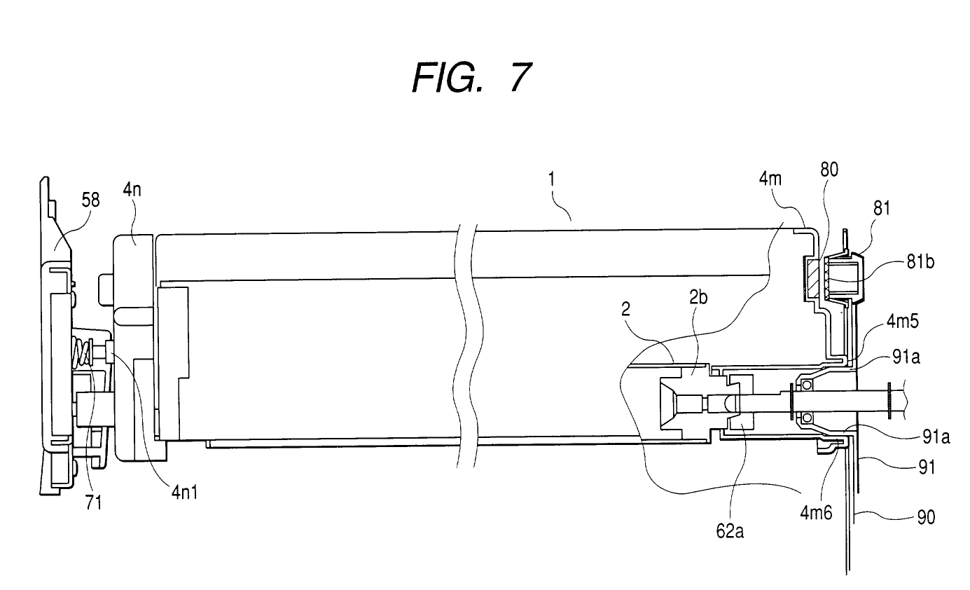

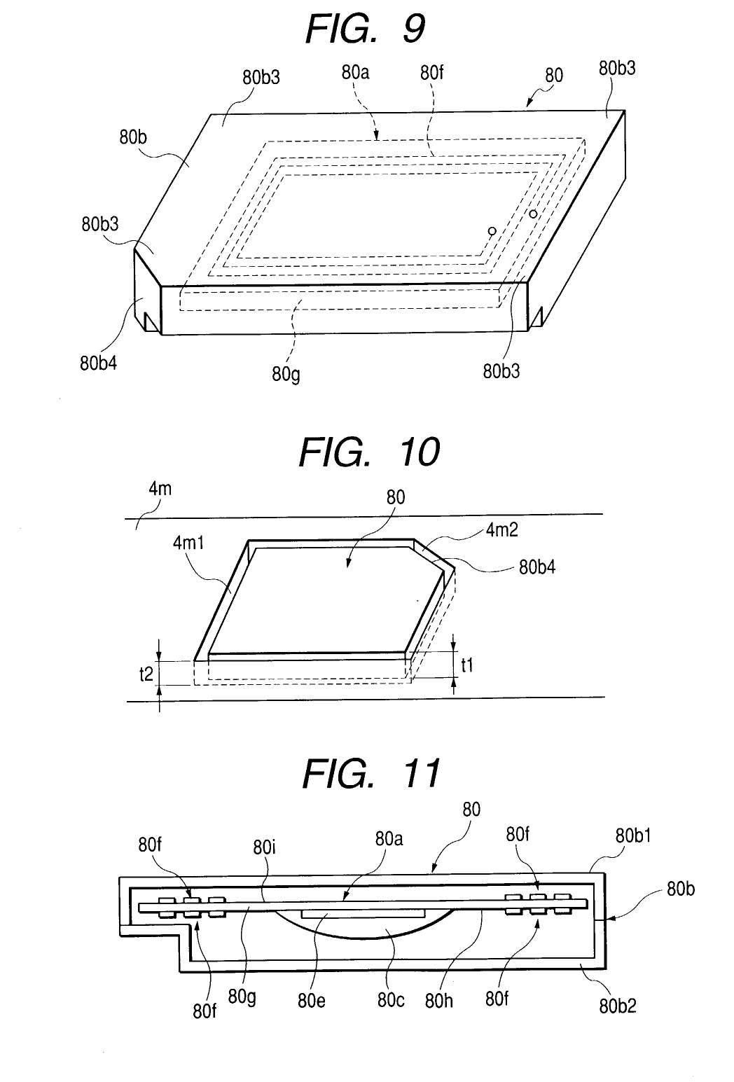

In FIGS. 6 and 7, a memory unit 80 is provided on the driving part side cover 4m of the process cartridge 1. And a communication unit 81 as communication means connected to a controller (not shown) is provided in the main body of the image forming apparatus 100. When the process cartridge 1 is mounted to the main body of the image forming apparatus 100, the antenna 80f (see FIGS. 9, 11, and 12) of the memory unit 80 faces the communication antenna 81b of the communication unit 81, and power is supplied to the memory 80e of the memory unit 80 and also the controller (not shown) of the main body of the apparatus 100 and the memory 80e can communicate with each other, allowing information to be read from/written to the memory 80e.

### Configuration and Mounting Configuration of Communication Unit

Next, the configuration and mounting configuration of the communication unit 81 of the main body of the image forming apparatus 100 will be described.

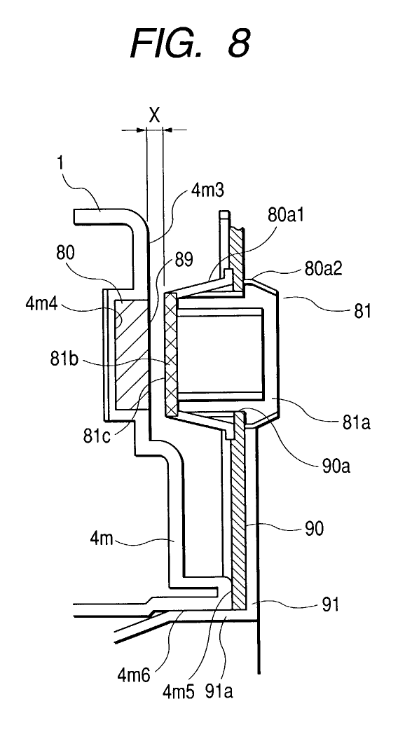

As shown in FIG. 8, the communication antenna 81 is attached to a communication unit holding member 81a. The communication antenna 81b may be attached to the communication unit holding member 81a using double-faced tape, adhesive, snap fitting, heat caulking, ultrasonic welding, and the like. And the communication unit holding member 81a is inserted to a hole 90a of base sheet metal 90 of the main body driving unit. The communication unit holding member 81a has a hook shape 81a1 with its tip protruding upward and downward, and is fixedly supported by being hooked with the hook.

The hook shape 81a1 is pressed into the holding member 81a against resilience through the hole 90a, and it goes back outwardly as it passes the hole 90a and gets fixed to the base sheet metal 90 by pinching the base sheet metal 90 with the flange 81a2 of the holding member 81a. Therefore, since the facing plane 81c between the end surface of the flange 80a2 contacting the surface of the base sheet metal 90 of the communication unit 81 and the memory unit 80 of communication antenna 81b is a certain size in the range of manufacturing error, the facing plane 81c has a fixed length of protruding from the base sheet metal 90.

### Configuration and Mounting Configuration of Memory Unit

The configuration and mounting configuration of a memory unit will be described next.

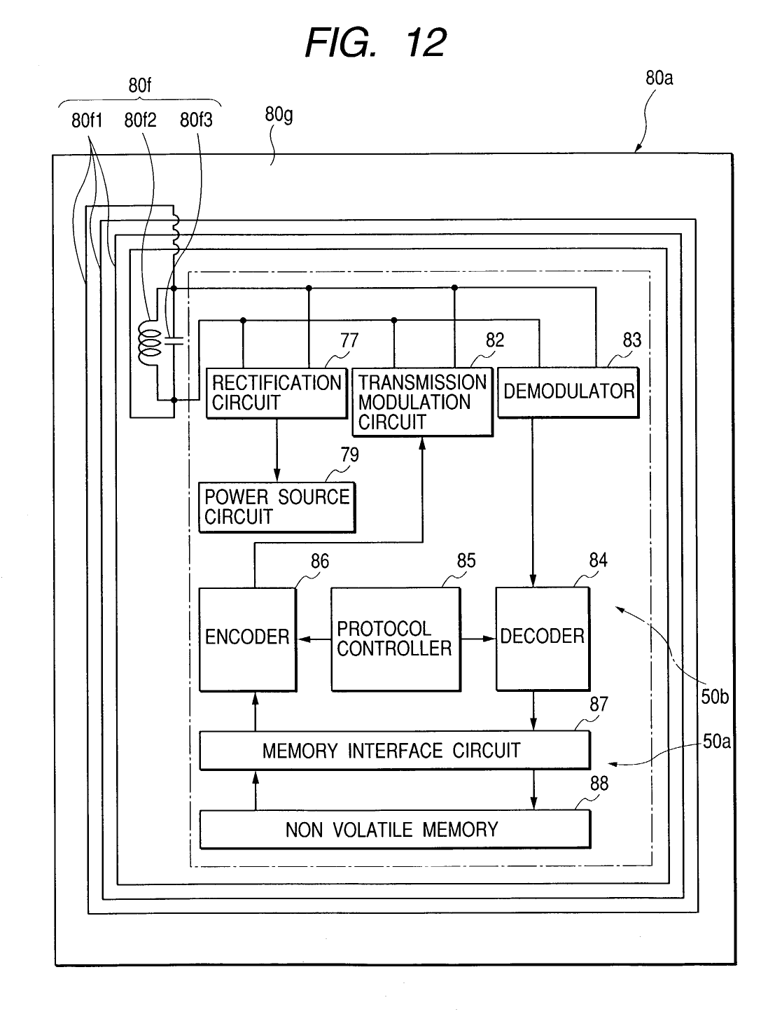

The configuration of memory unit 80 will be described. As shown in FIGS. 9, 10, and 11, the memory unit 80 as storage means has a card-like shape, consisting of a base plate unit (substrate unit) 80a and a protecting portion 80b as exterior member that covers the base plate unit 80a. The base plate unit 80a comprises memory 80e, a storage portion 50a, and a communication portion 50b. As shown in FIG. 11, the base plate unit 80a integrally incorporates memory 80e for storing information, an antenna 80f for communication that is a magnetic core as a memory antenna, and a base plate 80g as a main board on which the memory 80e and antenna 80f are mounted, into a unit. Memory 80e is provided on the rectangular base plate 80g made of epoxy resin. Specifically, the memory 80e is provided on the bottom side 80h of the base plate 80g (opposite side of the side facing the communication antenna 81b provided on the main body of the apparatus 100), and positioned surrounded by a continuity pattern 80f1 of the antenna 80f shown in FIG. 12. More specifically, the memory 80e is provided inside the pattern 80f1 almost at the center of the bottom side 80h of the base plate 80g. The memory 80e utilizes FERAM.

The memory 80e as storage portion is configured integrally with a transmission circuit constituting the communication portion 50b in FIG. 12. The antenna 80f is provided on the upper side 80i of the base plate 80g (on the side facing the communication antenna 81b provided on the main body of the apparatus 100). The antenna 80f has a pattern 80f1 of a spiral shape along the rectangular shape of the base plate 80g. The pattern 80f1 is formed on the base plate 80g with pattern printing. And the pattern 80f1 is connected to the memory 80e (FERAM). The base plate unit 80a thus configured is positioned inside the protecting portion 80b as a frame member. The protecting portion 80b consists of an upper frame 80b1 as an upper exterior portion and a bottom frame 80b2 as a bottom exterior portion made of polystyrene resin.

The upper frame 80b1 and the bottom frame 80b2 are connected with adhesive, welding, or ultrasonic welding after the base plate unit 80a is inserted. The protecting portion 80b as a frame member is made of a member having an induction rate of 2 to 5. Besides polystyrene resin, acrylnitrile butadiene resin and polycarbonate resin, for example, may be appropriately used for the material for non-conductive member.

The internal configuration of the memory unit 80 will be described using FIG. 12.

FIG. 12 illustrates the circuitry of the memory unit 80. As shown in FIG. 12, the memory 80e is configured integrally with transmission circuitry provided on the base plate 80g. The transmission circuitry sends information stored in the memory 80e to the antenna 80f. The antenna 80f includes of a coil 80f2, a capacitor 80f3, and a spiral continuity pattern 80f1. A rectification circuit for the transmission circuitry 77, a transmission modulation circuit 82, and a demodulator 83 are connected to the antenna 80f. The output of the rectification circuit 77 is connected to a power source circuit 79, supplying power to non-volatile memory 88. The memory 80e consists of a decoder 84, a protocol controller 85, an encoder 86, a memory interface circuit 87, and non-volatile memory 88 such as EEPROM or ferroelectric memory. After the demodulator 83 has demodulated high frequency wave into a base band signal, the signal is converted to a signal appropriate for sending it to non-volatile memory 88 by the decoder 84 under the control of the protocol controller 85. Then, the signal is divided into an address and data by the memory interface circuit 87, and an operation of reading to/writing from non-volatile memory is carried out according to a read/write command. Data read from the non-volatile memory is sent through the memory interface circuit 87 to the encoder 86 to be converted to a protocol suitable for communication by the protocol controller 85 and sent from the transmission modulation circuit 82 to the antenna 80f.

According to the embodiment, practicality is attained if the distance between the communication antenna 81b and the antenna 80f can be maintained at 1 mm to 10 mm.

FIG. 11 will be further described.

As shown in FIG. 11, the memory unit 80 of the embodiment is provided with the continuity patterns 80f1 of the antenna 80f on the upper side 80i of the base plate 80g (the side facing the communication antenna 81b of the main body of the apparatus 100), and on the bottom side 80h of the opposite side of the upper side 80i (the opposite side of the side facing the communication antenna 81b, that is, the side on which memory 80e is provided). Particularly, the continuity pattern 80f1 of the antenna 80f is provided such that it passes on the upper side 80i of the base plate 80g and then goes through the base plate 80g to the bottom side 80h of the base plate 80g, then it passes on the bottom side 80h of the base plate 80g and again goes through the base plate 80g to the upper side 80i of the base plate 80g. Holes in the base plate 80g are not illustrated. The continuity pattern 80f1 provided on the upper side 80i and bottom side 80h of the base plate 80g is electrically connected through these holes at its one end and the other end. And this continuity pattern 80f1 is electrically connected to transmission circuitry as a part of memory 80e. The pattern 80f1 has a spiral shape in conformity with the rectangular shape of the base plate 80g. Memory 80e is covered with a bonding 80c made of resin provided on the base plate 80g for protection. This enables the memory 80e to be protected from external impact exerted on the memory 80e in the process of manufacturing the base plate unit 80a, or assembling the upper frame 80b1, the bottom frame 80b2 and the base plate unit 80a into a memory unit.

To ensure the reliability of the communication antenna 81b and the antenna 80f, it is necessary to regulate the top and bottom sides of the memory unit 80 opposing to the communication antenna 81b, or each opposing position of the memory.

The embodiment thus regulates the upper and bottom sides of the memory unit 80 that faces the communication antenna 81b, or the position where they face each other. That is, as shown in FIG. 9, to regulate the mounting direction of the memory unit 80 in mounting the unit 80, a chamfer 80b4 as a regulating portion is provided on one of the multiple corners 80b3 on the periphery of the protecting portion 80b that is a frame member of the memory unit 80. The memory unit 80 is attached to the driving part side cover 4m. As shown in FIG. 10, a concave portion 4m1 for removably attaching the memory unit 80 is provided in the driving part side cover 4m. The concave portion 4m1 is provided at a position where the memory unit 80 faces the communication antenna 81b in the direction of inserting the process cartridge 1. That is, the concave portion 4m1 is provided at the end of the attachment direction of the cartridge and in the driving part side cover 4m. The concave portion 4m1 has a chamfer 4m2 as a regulating portion for the attachment direction of the memory unit 80 on one of the multiple corners on the inner periphery. In other words, the concave portion 4m1 has a shape almost the same as the plane shape of the memory unit 80. The chamfer 4m2 provided in the concave portion 4m1 has a shape that fits the chamfer 80b4 provided on one of the corners of memory unit 80.

When the memory unit 80 is mounted to the concave portion 4m1, the memory unit 80 is fit into the concave portion 4m1 in the attachment direction of the memory unit 80 with the chamfer 80b4 and the chamfer 4m2 aligned. This enables the regulation of the upper and bottom sides of the memory unit 80 to the communication antenna 81b or the facing position. It can also prevent the memory unit 80 from being attached upside down. And a mistake of the direction in which the memory element 50 is mounted can be avoided. The depth t2 of the concave portion 4m1 is the thickness t1 of the memory unit 80.

The driving part side cover 4m is an integral molding of a synthetic resin, and the longitudinal distance between the bottom 4m4 of the concave portion 4m1 and the pressing portion 4m5 where the driving part side cover 4m is pressed against the base sheet metal 90 is controlled so as to reduce the manufacturing error. The bottom 4m4 of the concave portion 4m1 and the end surface of the pressing portion 4m5 are parallel, and the bottom 4m4 of the concave portion 4m1 and the plane of the base sheet metal 90 are parallel. In some embodiments, the end surface of the pressing portion 4m5 and the outer surface 89 of the memory unit 80 may be the common plane.

As has been described, the driving part side cover 4m is a positioning member for the process cartridge 1 relative to the main body of the apparatus 100 in the longitudinal direction and also is a positioning member for the memory unit as storage means relative to the main body of the apparatus 100.

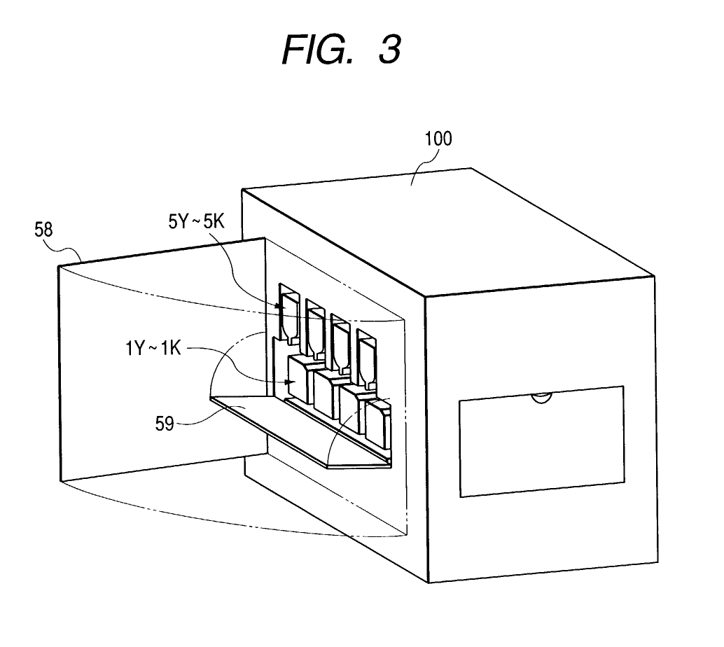

As shown in FIG. 6, the memory unit 80 is attached to the driving part side cover 4m. It may be attached with double-faced tape, adhesive, snap fit, heat caulking, ultrasonic welding and the like. And the memory unit 80 of course has strength that prevents detachment due to vibration when a user touches the unit, or attaches a process cartridge 1 to the image forming apparatus 100 and closes the centering plate 59 shown in FIG. 3.

The process cartridge 1 has the driving part side cover 4m and non-driving part side cover 4n fixed at the both ends of the longitudinal direction of the frame body proper 4p that is longitudinally long.

### Securement of a Gap Between a Memory Unit and a Communication Unit

In the following, a gap X between the memory unit 80 and the communication unit 81 will be described.

The gap X refers to the distance between the outer surface 89 of the memory unit 80 and the facing plane 81 of the communication antenna that faces the outer surface 89 in parallel.

As shown in FIG. 7, the process cartridge 1 attached with the memory unit 80 is configured such a way that, when the cartridge 1 is mounted to the main body of the image forming device 100, the pushed portion 4n1 of the non-driving part side cover 4n is pushed by the energizing spring 71 coupled to the front door 58 to press the pressing portion 4m5 arranged at an outer end portion of a hole portion 4m6 in the driving part side cover 4m against the base sheet metal 90 of the main body driving unit so that the position in the longitudinal direction is regulated. The energizing spring 71 of the embodiment generates a spring force of about 500 gf to 1500 gf when the front door 58 is closed. The driving part side cover 4m is molded with resin, allowing part accuracy to be created. Thus, the memory unit 80 can be accurately fixed so that the outer surface 89 of the memory unit 80 and the outer surface 4m3 of the driving part side cover 4m (see FIG. 8) will be the common plane. The communication unit 81 is also fixed directly to the base sheet metal 90 of the main body driving unit. Accordingly, by pressing the driving part side cover 4m against the base sheet metal 90, the accumulation of each part's tolerance can be minimized. Thus, the gap X between the memory unit 80 and the communication unit 81 can be accurately maintained as means for canceling the accumulation of part tolerances, without, for example, the need for the communication unit 81 to be movable. Here, the gap X represents the distance between the outer surface 89 of the memory unit 80 and the communication antenna side facing plane 81c that faces the outer surface 89. Although the embodiment has addressed the process cartridge, the invention may be applied to each unit such as a development cartridge which incorporates a developer container containing developer and a developing member as a unitary cartridge which can be detachably mounted to the main body of the apparatus, or a toner cartridge.

Also, in the embodiment, the hole portion 4m6 (cylindrical member) is provided on the driving part side cover 4m (cover member) that fits the supporting pin 63 (main body supporting member) provided in the apparatus main body 100 so that the process cartridge 1 is positioned relative to the apparatus main body 100 in the direction which intersects the direction of mounting the process cartridge 1. And the pressing portion 4m5 (unit pressing portion) is provided in the hole portion 4m6 (cylindrical member) at its end in terms of the mounting direction.

Thus, positioning in the direction in which the process cartridge 1 is mounted and the direction which intersects the mounting direction can be made with the hole portion 4m6 (cylindrical member). It means that the process cartridge 1 can be smaller. In addition, since the pressing portion 4m5 (unit pressing portion) as a positioning portion for the mounting direction is cylindrical, the distance for which the base sheet metal 90 (main body base member) contacts the pressing portion 4m5 can be made long, positioning the process cartridge 1 stably without causing it to wobble.

To summarize the process cartridge, development cartridge, and toner cartridge:

the process cartridge is a process cartridge 1 that can be detachably mounted to the main body of an image forming apparatus 100 and includes

an electrophotographic photosensitive drum 2,

process means that acts on the electrophotographic photosensitive drum 2, and

a memory element 88 that has a communication antenna 80f and communication means 50b,

and has a memory unit 80 as storage means that can communicate with a communication unit 81 as communication means which is fixedly disposed in the main body of the image forming apparatus 100 in a non-contacting manner, and a positioning member 4m5 that has a contacting plane that is energized toward the main body of the image forming apparatus 100 by an energizing spring 71 to contact the base sheet metal 90 of the main body of the image forming apparatus 100 and positioned in the direction opposite to the direction of the communication means 81 fixedly placed on the image forming apparatus 100, wherein the storage means 80 is on a common or parallel plane integrally formed with the contacting surface of the positioning member 4m5.

The development cartridge is a development cartridge (4) that can be detachably mounted to the main body of the image forming apparatus 100, comprising

a developing sleeve 4a that is a developing member for developing an electrostatic latent image formed on the electrophotographic photosensitive drum 2;

a developer container (4h) for containing developer to be supplied to the developing member; and

a memory element 88 that has a communication antenna 80f and a communication means 50b,

and has a memory unit 80 that is as storage means that can communicate with the communication unit 81 as communication means which is fixedly disposed in the main body of the image forming apparatus 100 in a non-contacting manner, and a positioning member that has a contacting plane which is energized toward the main body of the image forming apparatus 100 to contact the main body and is positioned in the direction opposite to the direction of the communication means fixedly disposed in the main body of the image forming apparatus, wherein the storage means is on a common or parallel plane integrally formed with the contacting plane of the positioning member.

The toner cartridge is a toner replenishment container 5 as a toner cartridge that can be detachably mounted to the main body of the image forming apparatus 100, including

a container proper 5g for containing developer to be supplied to a developing device 4 provided in the main body of the image forming apparatus 100 and having an discharge opening 5f for discharging the developer to the developing device 4,

a screw 5a, an agitating plate 5c, and an agitating axis 5c as carrying members that agitate the developer in the container proper and carry it toward the discharge opening, and

a memory element 88 that has a communication antenna 80f and a communication means 50b,

and has a memory unit 80 as storage means that can communicate with a communication unit 81 as communication means fixedly disposed in the main body of the image forming apparatus 100 in a non-contacting manner, and a positioning member that has a contacting plane that is energized toward the main body of the image forming apparatus 100 to contact the main body and is positioned in the direction opposite to the direction of the communication means fixedly disposed in the main body of the image forming apparatus 100, wherein the storage means (80) is on a common or parallel plane integrally formed with the contacting plane of the positioning member.

As has been described, according to the invention, the communication between the communication means provided in the electrophotographic image forming apparatus and storage means can be ensured.

It is also possible to maintain a fixed distance between the communication means provided in the electrophotographic image forming apparatus and the storage means.

And it is also possible to simplify the configurations of the communication means provided in the electrophotographic image forming apparatus and storage means.

What is claimed is:

1. A unit that can be detachably mounted to a an electrophotographic image forming apparatus main body having a main body base member fixedly disposed and communication means provided in the main body base member, comprising:
a cover member;
a unit abutting portion provided on said cover member and abutting against the main body base member, for positioning said unit to said apparatus main body when said unit is being mounted to said apparatus main body; and
a memory element provided on said cover member and disposed at a position facing said communication means, capable of communicating with said communication means in a non-contacting manner.

2. A unit according to claim 1, wherein said unit abutting portion is provided integrally with said cover member, and further, said memory element is provided on a common or a parallel plane with said unit abutting portion.

3. A unit according to claim 1, wherein said unit abutting portion is provided at an end in a mounting direction in which said unit is being mounted onto said apparatus main body, and said unit is positioned in the mounting direction to said apparatus main body by said unit abutting portion abutting against the main body base member.

4. A unit according to claim 3, further comprising a cylindrical member provided on said cover member for fitting with a main body supporting member provided in said apparatus main body to position said unit to said apparatus main body in a direction intersecting the mounting direction, wherein said unit abutting portion is provided at an end of said cylindrical member in the mounting direction.

5. A process cartridge that can be detachably mounted to an electrophotographic image forming apparatus main body having a main body base member fixedly disposed and communication means provided in said main body base member, comprising:
an electrophotographic photosensitive member;
process means for acting on said electrophotographic photosensitive member;
a cover member;
a unit abutting portion provided on said cover member and abutting against said main body base member, for positioning said process cartridge to said apparatus main body when said process cartridge is being mounted to said apparatus main body; and
a memory element provided on said cover member and is disposed at a position facing said communication means, capable of communicating with said communication means in a non-contacting manner.

6. A process cartridge according to claim 5, wherein said unit abutting portion is provided integrally with said cover member, and further, said memory element is provided on a common or parallel plane with said unit abutting portion.

7. A process cartridge according to claim 5, wherein said unit abutting portion is provided at an end in a mounting direction in which said process cartridge is mounted onto said apparatus main body, and said process cartridge is positioned in the mounting direction to said apparatus main body by said unit abutting portion abutting against said main body base member.

8. A process cartridge according to claim 7, further comprising a cylindrical member provided on said cover member for fitting with a main body supporting member provided in said apparatus main body to position said process cartridge to said apparatus main body in a direction intersecting the mounting direction, and said unit abutting portion is provided at an end of said cylindrical member in the mounting direction.

9. A development cartridge that can be detachably mounted to an electrophotographic image forming apparatus main body having a main body base member fixedly disposed and communication means provided on said main body base member, comprising:
a developing member for developing an electrostatic latent image formed on an electrophotographic photosensitive member;
a toner container for containing toner to be supplied to said developing member;
a cover member;
a unit abutting portion provided on said cover member and abutting against said main body base member, for positioning said development cartridge to said apparatus main body when said development cartridge is mounted to said apparatus main body; and
a memory element provided on said cover member and disposed at a position facing said communication means, capable of communicating with said communication means in a non-contacting manner.

10. A development cartridge according to claim 9, wherein said unit abutting portion is provided integrally with said cover member, and further, said memory element is provided on a common or parallel plane with said unit abutting portion.

11. A development cartridge according to claim 9, wherein said unit abutting portion is provided at an end in a mounting direction in which said development cartridge is being mounted onto said apparatus main body, and said development cartridge is positioned in the mounting direction to said apparatus main body by said unit abutting portion abutting against said main body base member.

12. A development cartridge according to claim 11, further comprising a cylindrical member that is provided on said cover member and fits with a main body supporting member provided in said apparatus main body to position said development cartridge to said apparatus main body in a direction intersecting the mounting direction, wherein said unit abutting portion is provided at the end in a direction in which said cylindrical member is mounted.

13. A toner cartridge that can be detachably mounted to an electrophotographic image forming apparatus main body having a main body base member fixedly disposed and communication means provided in said main body base member, comprising:
a toner container that contains toner to be supplied to a developing apparatus provided in said apparatus main body and has a toner supplying opening for supplying the toner to said developing apparatus;
a carrying member for agitating the toner in said toner container and carrying it to the toner supplying opening;
a cover member;
a unit abutting portion provided on said cover member and abutting against said main body base member, for positioning said toner cartridge to said apparatus main body when said toner cartridge is being mounted to said apparatus main body; and
a memory element that is provided on said cover member and is disposed at a position facing said communication means, capable of communicating with said communication means in a non-contacting manner.

14. A toner cartridge according to claim 13, wherein said unit abutting portion is provided integrally with said cover member, and further, said memory element is provided on a common or parallel plane with said unit abutting portion.

15. A toner cartridge according to claim 13, wherein said unit abutting portion is provided at an end in a direction in which said toner cartridge is being mounted onto said apparatus main body, and said toner cartridge is positioned in the mounting direction to said apparatus main body by said unit abutting portion abutting against the said main body base member.

16. A toner cartridge according to claim 15, further comprising a cylindrical member provided on said cover member that fits with a main body supporting member provided in said apparatus main body to position said toner cartridge to said apparatus main body in a direction intersecting the mounting direction, wherein said unit abutting portion is provided at an end of said cylindrical member in the mounting direction.

17. An electrophotographic image forming apparatus to which a unit can be detachably mounted, for forming an image on a recording medium, having:
(i) a main body base member fixedly disposed,
(ii) communication means provided on said main body base member,
(iii) mounting means for mounting a unit that has a cover member, a unit abutting portion that is provided on said cover member and abutting against said main body base member, for positioning said unit to said electrophotographic image forming apparatus main body when said unit is being mounted onto said apparatus main body, and a memory element provided on said cover member and disposed at a position facing said communication means, capable of communicating with said communication means in a non-contacting manner, and
(iv) conveying means for conveying said recording medium.

18. An electrophotographic image forming apparatus to which a process cartridge can be detachably mounted, for forming an image on a recording medium, having:
(i) a main body base member,
(ii) communication means fixedly provided on said main body base member,
(iii) mounting means for detachably mounting a process cartridge having an electrophotographic photosensitive member, process means that affects said electrophotographic photosensitive member, a cover member, a unit abutting portion provided integrally with said cover member and abutting against said main body base member when said unit is being mounted to said apparatus main body, for positioning a mounting direction in which said unit is being mounted onto said apparatus main body, a pushed portion that is pushed by energizing means in a direction in which said unit abutting portion abuts against said main body base member, and a memory element fixedly disposed at a position on said cover member that faces said communication means, capable of communicating with said communication means in a non-contacting manner, and
(iv) conveying means for conveying said recording medium.

19. An electrophotographic image forming apparatus to which a toner cartridge can be detachably mounted, for forming an image on a recording medium, comprising:
(i) a main body base member,
(ii) communication means fixedly provided on said main body base member,
(iii) mounting means for detachably mounting a development cartridge having a toner container for containing toner to be supplied to a developing apparatus provided in a main body of said apparatus and has a toner supplying opening for supplying the toner to said developing apparatus, a carrying member that agitates the toner in said toner container and carries the toner to the toner supplying opening, a cover member, a unit abutting portion provided on said cover member and abutting against said main body base member, for positioning said toner cartridge to the main body of said electrophotographic image forming apparatus when the toner cartridge is being mounted onto said main body, and a memory element provided on said cover member and disposed at a position facing said communication means, capable of communicating with said communication means in a non-contacting manner, and
(iv) conveying means for conveying said recording medium.

20. A electrophotographic image forming apparatus according to any one of claims 17, 18, and 19, further comprising energizing means for pushing said toner cartridge in a direction said unit abutting portion abuts against said main body base member.
